(19) United States
(12) Patent Application Publication
(10) Pub. No.: US 2012/0251081 A1
(43) Pub. Date: Oct. 4, 2012

(54) IMAGE EDITING DEVICE, IMAGE EDITING METHOD, AND PROGRAM

(75) Inventor: Yoshifumi Kawaguchi, Kyoto (JP)

(73) Assignee: PANASONIC CORPORATION, Osaka (JP)

(21) Appl. No.: 13/433,365

(22) Filed: Mar. 29, 2012

(30) Foreign Application Priority Data
Mar. 30, 2011 (JP) 2011-075028

(51) Int. Cl. G11B 27/00

(52) U.S. Cl. 386/278

(57) ABSTRACT

The image editing device creates the sequence of images by combining a plurality of images each of which has ancillary information. The image editing device includes: an input interface for receiving a plurality of candidate images that are specified as editing targets; and an image editing unit for creating the sequence of images by giving a characteristic displaying effect to each group consisting of at least two images that are extracted from the plurality of candidate images based on the ancillary information, and then by aligning the groups.

### BACKGROUND OF THE INVENTION

1. Field of the Invention

The present invention relates to an image editing device capable of editing a sequence of images to be displayed in succession by combining a plurality of images.

2. Description of the Related Art

There have been known electronic devices and programs for editing a plurality of still images and moving images to create a photo movie. For example, Japanese Patent Application Laid-open No. 2006-157197 discloses a photo movie creating device that creates a photo movie watching by combining a plurality of still images as materials.

When constructing a group of images to be displayed in succession as in a photo movie, display effects (displaying effects rendered to the respective images) influence the visual impression of the sequence of images displayed in succession. With the photo movie creating device of Japanese Patent Application Laid-open No. 2006-157197, however, it is not easy to create a sequence of images that conforms to the user's intention.

### SUMMARY OF THE INVENTION

Embodiments of the present invention have been developed in view of the problem described above, and therefore provide an image editing device that makes the extraction of material images conforming to the user's intention more easy when creating a sequence of images to be displayed in succession as in a photo movie.

An image editing device according to an exemplary embodiment of the present invention is capable of creating a sequence of images by combining a plurality of images each of which has ancillary information. The image editing device includes: an input interface for receiving a plurality of candidate images that are candidates for images used in the sequence of images; and an image editing unit configured to create the sequence of images by giving a characteristic displaying effect to each group consisting of at least two images that are extracted from the plurality of candidate images based on the ancillary information, and then by aligning the groups.

In one exemplary embodiment, the input interface receives, from a user, the plurality of candidate images, information that defines a total play time of the sequence of images, and information that defines a configuration of the sequence of images, and, based on the information that defines the total play time and the information that defines the configuration, the image editing unit determines a play time for each of a plurality of scenes which constitute the sequence of images.

In another exemplary embodiment, based on the ancillary information, the image editing unit sorts the plurality of candidate images into images that constitute groups and images that do not constitute groups, allocates the images that constitute groups to one of the plurality of scenes on a group-by-group basis, and allocates at least part of the images that do not constitute groups to remaining scenes of the plurality of scenes on an image-by-image basis.

In another exemplary embodiment, the information that defines the configuration is determined by the user by selecting one template out of a plurality of prepared templates.

In another exemplary embodiment, the image editing unit uses, as a reference, a value of ancillary information attached to a still image or a moving image that is included in the plurality of candidate images, and executes processing of detecting from among the plurality of candidate images another still image or a moving image whose ancillary information has a value within a given range from the reference, to thereby determine the groups.

In another exemplary embodiment, the image editing unit determines the groups by executing the processing for every still image or every moving image that is included in the plurality of candidate images.

In another exemplary embodiment, the displaying effect given to each group separately includes an effect in which at least two images belonging to the group are displayed in the same display area.

In another exemplary embodiment, the displaying effect includes an effect in which at least one of the at least two images displayed in the same display area performs at least one of a shifting action, an expansion action, and a reduction action.

In another exemplary embodiment, the ancillary information includes at least one of information that indicates a photographing period, information that indicates a photographing location, and information for identifying a subject.

An image editing method according to an exemplary embodiment of the present invention is a method of creating a sequence of images by combining a plurality of images each of which has ancillary information. The method includes: receiving a plurality of candidate images that are specified as editing targets; and creating the sequence of images by giving a characteristic displaying effect to each group consisting of at least two images that are extracted from the plurality of candidate images based on the ancillary information, and then by aligning the groups.

A computer program according to an exemplary embodiment of the present invention is a program stored on a non-transitory computer-readable medium to be executed by a computer mounted in an image editing device for creating a sequence of images by combining a plurality of images each of which has ancillary information. The image editing program causes the computer to execute: receiving a plurality of candidate images that are specified as editing targets; and creating the sequence of images by giving a characteristic displaying effect to each group consisting of at least two images that are extracted from the plurality of candidate images based on the ancillary information, and then by aligning the groups.

According to the present invention, there may be provided an image editing device that makes the extraction of material images conforming to the user's intention more easy when editing a sequence of images to be displayed in succession as in a photo movie.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1A is a diagram illustrating a basic configuration of an image editing device according to embodiments of the present invention.

FIG. 1B is a conceptual diagram of conte data creation according to a first embodiment.

FIG. 2 is a configuration diagram of a PC according to the first embodiment.

FIG. 3 is a configuration diagram of a conversion processing unit according to the first embodiment.

FIG. 4 is an imagery diagram of multiplexing processing according to the first embodiment.

FIG. 5 is a conceptual diagram of the structure of a still image file according to the first embodiment.

FIG. 6A is a conceptual diagram illustrating an example of the structure of a moving file according to the first embodiment.

FIG. 6B is a conceptual diagram illustrating another example of the structure of a moving file according to the first embodiment.

FIG. 7 is a conceptual diagram of the structure of a database according to the first embodiment.

FIG. 8 is an imagery diagram of a selection screen of a liquid crystal display according to the first embodiment.

FIG. 9A is an imagery diagram of a preview screen of the liquid crystal display according to the first embodiment.

FIG. 9B is a diagram illustrating an example of specifics described in a template according to the first embodiment.

FIG. 10 is a main flow chart according to the first embodiment.

FIG. 11 is a detailed flow chart of conte creation according to the first embodiment.

FIG. 12 is a detailed flow chart of processing of creating conte data by arranging extracted data in story data according to the first embodiment.

FIG. 13 is a conceptual diagram of group scene extraction (photographing date/time) according to the first embodiment.

FIG. 14 is an imagery diagram illustrating an example of visual effects according to the first embodiment.

FIG. 15 is a conceptual diagram of data sets in relation to a group scene according to the first embodiment.

FIG. 16 is a conceptual diagram of group scene extraction (photographing location) according to one of the other embodiments.

FIG. 17 is a conceptual diagram of how visual effects are rendered to a group scene according to one of the other embodiments.

### DETAILED DESCRIPTION OF PREFERRED EMBODIMENTS

Embodiments of the present invention are described below. Before a description is given on a concrete embodiment, a basic configuration in the embodiments of the present invention is described first.

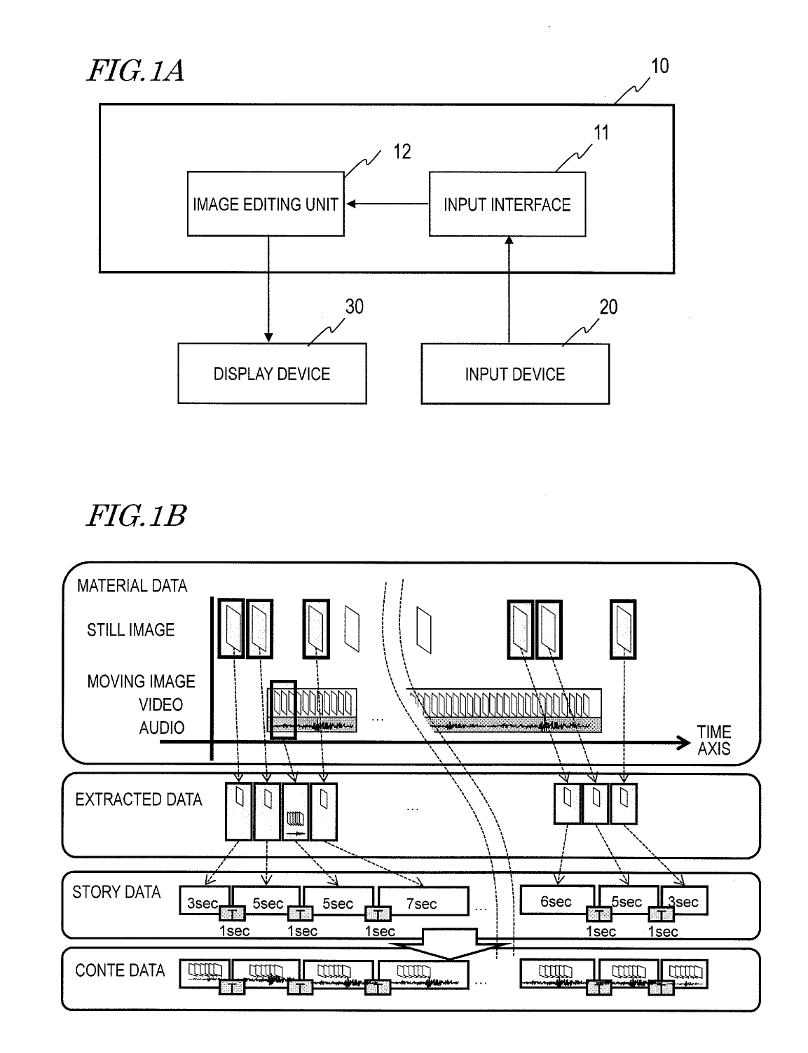

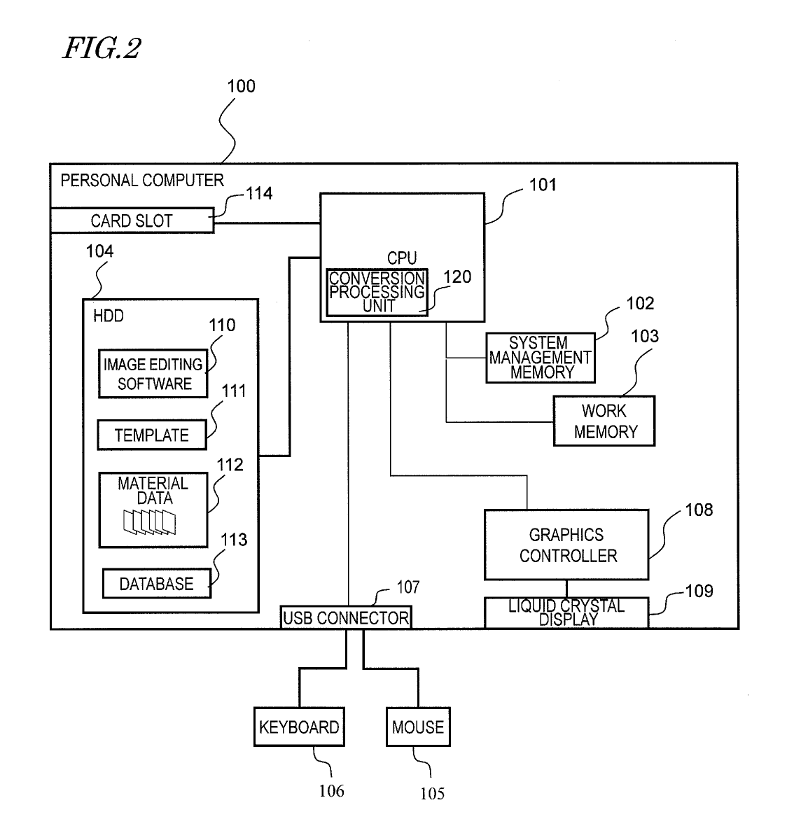

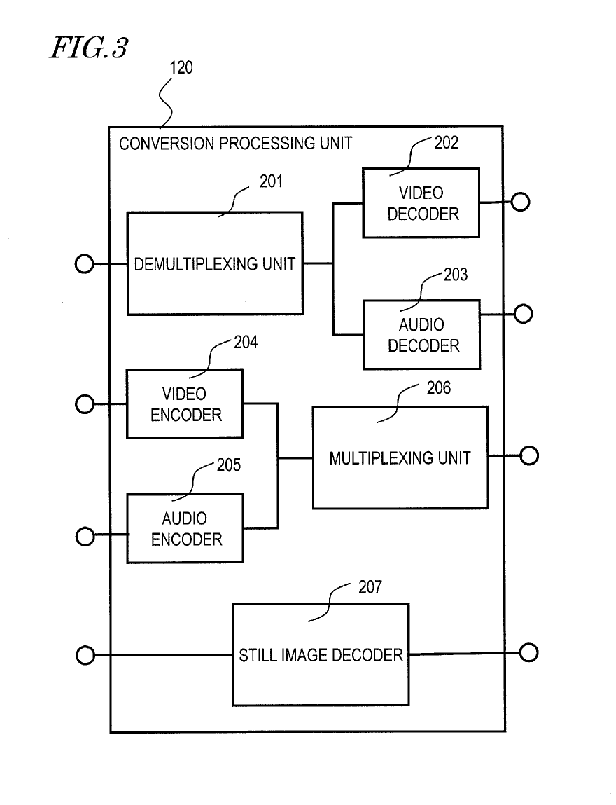

FIG. 1A is a block diagram illustrating the basic configuration of an image editing device, which is denoted by 10, according to the embodiments of the present invention. The image editing device 10 can be electrically connected to an external input device 20 and an external display device 30 for use. The phrase “electrically connected” refers to the case where information is transmitted on electromagnetic waves in addition to the case where the connection is a physical connection via a cable such as a copper wire or an optical fiber. The image editing device 10 is typically an electronic device that includes a processor, such as a personal computer (hereinafter, referred to as “PC”) or a portable information terminal. The image editing device 10 may be a server set up at a data center or the like. The input device 20 and the display device 30 in this case can be an input/output device built inside or connected to an electronic device that is operated by a user in a place remote from the image editing device 10.

The image editing device 10 has a function of creating a sequence of images from a plurality of images. The term “sequence of images” as used herein means a video consisting of a plurality of images that are displayed in succession accompanied by given displaying effects. The video may include not only sequential display in which a plurality of still images and/or moving images are displayed one by one, but also a scene in which a plurality of still images are displayed simultaneously, a scene in which a plurality of moving images are displayed simultaneously, and a scene in which a plurality of still images and moving images are displayed simultaneously. In a typical embodiment, images constituting a sequence of images are prepared as individual still image files or moving image files.

“Displaying effects” are embellishing effects presented when the respective images are displayed. Examples of displaying effects include inserting an image to the screen such that the image slides into view from a side, and displaying an image on the screen while increasing or decreasing the image in size. A scene where a plurality of images are displayed simultaneously may be given an effect in which some of the images perform complicate actions on the screen such as shifting and increasing or decreasing in size.

The term “image” includes still images and moving images. In the case where a created sequence of images includes a moving image, the moving image can be played only for the duration of a play time allotted to this moving image. In the case where the images are moving images each consisting of at least one photo, the sequence of images may be called a “photo movie”.

The image editing device 10 includes an input interface 11, which receives candidate images to be used in a sequence of images via the input device 20, and an image editing unit 12, which creates a sequence of images based on input information.

The input interface 11 is a device that receives information input from the input device 20 and can be, for example, a USB port or a communication port. Information input to the input interface 11 is transferred to the image sequence creating unit 12 and the image editing unit 12. Alternatively, the input information may be recorded in a memory (not shown). A plurality of candidate images specified as editing targets by the user or the like are input to the input interface 11. Each candidate image has ancillary information attached thereto. The ancillary information of an image can include parameters that characterize the image, such as the photographing time, the photographing location, and personal identification information.

An image editing unit 13 creates a sequence of images from a plurality of images that are selected from a plurality of specified candidate images. The created sequence of images can be saved in, for example, a memory (not shown) to be displayed on the display device 30. The image editing unit 13 creates a sequence of images by rendering a characteristic displaying effect to each group consisting of at least two images that are extracted from a plurality of specified candidate images based on the images' ancillary information, and then aligning the groups.

The configuration described above can create a sequence of images edited for each group consisting of a plurality of highly correlated images. A sequence of images of higher quality that reflects the user's intention is thus obtained with ease.

More concrete embodiments of the present invention are described below.

### First Embodiment

An image editing device according to a first embodiment of the present invention is described first. In this embodiment, a personal computer (PC) functions as the image editing device. A PC according to this embodiment allows a user to easily edit pieces of material data (still images and moving images) of the user's choice in a manner that places importance on the story line and time, the characteristics of the materials, and the user's intention.

This embodiment deals with a case of creating a photo movie (hereinafter, sometimes simply referred to as “movie”) as an edit result.

FIG. 1B is a conceptual diagram illustrating the overall flow of movie creating processing in this embodiment. FIG. 1B illustrates the flow from the extraction of material data to be used in movie creation from among candidate material data, to the creation of “story data” which indicates the basic structure of the movie, and to the creation of “conte data” which associates the “story data” and the extracted data with each other. The imagery shown in FIG. 1B is of a case where pieces of material data constituted of a plurality of still images and moving images are aligned in time series based on the dates and times at which those images are obtained. A moving image in FIG. 1B is divided into video and audio.

When creating a movie, the PC according to this embodiment creates story data of a given length of time in accordance with a specified template from pieces of material data (still images and moving images) of the user's choice.

The PC first extracts image data to be used in movie creation (extracted data) from among the still images and moving images that are included in the material data. In the case where the extracted data includes a moving image, the extracted moving image is divided into a necessary length because using the stream of images in its entire length makes the play time too long.

A “template” describes the play times of video images arranged in sequence and displaying effects rendered to video images or to switches between video images in order to represent a story having a given length of time. A video image here means a moving image that has been readied to play for a fixed length of time by giving specified displaying effects to still images and moving images.

“Story data” is a description that places the count of images to be displayed, the display times of the respective images, and displaying effects of the respective images on a time axis.

“Content data” is data created by extracting video images that are likely to be important to the user from among pieces of material data (still images and moving images) selected by the user, and arranging the extracted video images in an effective manner. The PC, which is denoted by 100, performs given encoding processing on the conte data to convert the conte data into a moving image file and output the moving image file.

When selecting the extracted data, the PC 100 according to this embodiment sets a group scene to pieces of image data (a plurality of still images, a plurality of moving images, or a combination of still images and moving images) that share similar ancillary information, and edits the movie on a group scene-by-group scene basis.

The system configuration and operation of the PC 100 are described below in detail.

### 1. System Configuration

The system configuration of the PC 100 is described first with reference to FIG. 2. FIG. 2 is a block diagram illustrating the overall configuration of the PC 100.

The PC 100 includes a central processing unit (CPU) 101, a system management memory 102, a work memory 103, a hard disk drive (HDD) 104, a USB connector 107, a graphics controller 108, a liquid crystal display 109, and a card slot 114. The USB connector 107 can be connected to a mouse 105 and a keyboard 106. The PC 100 can include other components than the ones illustrated in the drawing, but those components are irrelevant to the essence of the present invention and are therefore omitted from the drawing. The PC 100 which is a notebook PC that includes the liquid crystal display 109 in this embodiment may also be a desktop PC. In this embodiment, the CPU 101 has the function of the image editing unit of the present invention.

The CPU 101 executes processing of the PC 100. The CPU 101 is electrically connected to the system management memory 102, the work memory 103, the HDD 104, the graphics controller 108, and the USB connector 107. The CPU 101 can change an image displayed on the liquid crystal display 109 via the graphics controller 108. The CPU 101 also receives via the USB connector 107 information about an operation made by the user with the mouse 105 and/or the keyboard 106. Though not illustrated, the CPU 101 also handles the overall system control which includes controlling power supply to the components of the PC 100.

The system management memory 102 is a memory that holds an operating system (OS) and the like. The system management memory 102 also stores system time, which is updated by the running of a program of the OS by the CPU 101.

The work memory 103 is a memory that temporarily stores information necessary for the CPU 101 to execute various types of processing. The CPU 101 uses the work memory 103 as a workspace when creating story data of a given length of time in accordance with a template specified by the user. The work memory 103 stores information of material data specified by the user, information of a template specified by the user, story data that is being created, created conte data, and the like.

The HDD 104 stores image editing software 110, templates 111, material data 112 (a plurality of still images and moving images), and a database 113 which manages information of the material data 112. Details of the templates 111, the material data 112, and the database 113 are described later.

The mouse 105 is a pointing device used by the user for an editing operation. The user operates the mouse 105 to select material data 112 and a template 111 on the screen of image editing software 110.

The keyboard 106 is a keyboard device which allows the user to input letters and the like in an editing operation.

The USB connector 107 is a connector for connecting the mouse 105 and the keyboard 106 to the PC 100.

The graphics controller 108 is a device that visualizes screen information computed by the CPU 101, and transmits the screen information to the liquid crystal display 109.

The liquid crystal display 109 is a display device that displays screen information visualized by the graphics controller 108. The screen information may be displayed on an external display instead of the liquid crystal display 109.

The card slot 114 is an interface through which a memory card can be loaded into the PC 100. When a memory card is inserted to the card slot 114, the CPU 101 can read image data or the like that is stored in the memory card. When necessary, the CPU 101 can also write in the HDD 104 image data or the like that is stored in the memory.

The CPU 101 reads image editing software 110 that is stored in the HDD 104 and stores the image editing software in the work memory 103 to activate and execute the image editing software 110. The CPU 101 also executes the following processing in accordance with a program of the image editing software 110:

(1) Receiving via the USB connector 107 a selection operation and an editing operation which are made by the user with the mouse 105 and/or the keyboard 106.

(2) Reading the material data that is selected by the user for conte data to be created.

(3) Reading what is written in a template 111 that is selected by the user.

(4) Creating story data of a given length of time that is specified by the user in accordance with what is written in the template 111 selected by the user.

(5) Creating conte data by extracting preferentially video images that are assumed to be important to the user from among the material data selected by the user, and arranging the extracted video images in an effective manner.

(6) Sending image information of the created conte data to the graphics controller 108 in order to display the conte on the liquid crystal display 109.

(7) Playing the movie in accordance with the specifics of the created conte data for a preview on the liquid crystal display 109.

Material data is compressed in a given format in some cases, and the PC 100 decodes compressed material data in a conversion processing unit 120. The conversion processing unit 120 in this embodiment is described as one of processing functions of the CPU 101, but the present invention is not limited thereto. Specifically, the conversion processing unit 120 may be implemented as an external function of the CPU 101.

### 2. Configuration of the Conversion Processing Unit

The configuration of the conversion processing unit 120 of the PC 100 is described next with reference to FIG. The conversion processing unit 120 executes decompression decoding processing of the material data 112 that has been compression-encoded and stored in the HDD 104. The conversion processing unit 120 includes a demultiplexing unit 201, a video decoder 202, an audio decoder 203, a video encoder 204, an audio encoder 205, a multiplexing unit 206, and a still image decoder 207.

The demultiplexing unit 201 demultiplexes an AV stream that has been multiplexed in AVCHD (a registered trademark) or other file formats into a video stream and an audio stream. The demultiplexed video stream and audio stream are sent to the video decoder 202 and the audio decoder 203, respectively.

The video decoder 202 performs decompression decoding on a video stream demultiplexed from an AV stream by the demultiplexing unit 201. The audio decoder 203 performs decompression decoding on an audio stream demultiplexed from an AV stream by the demultiplexing unit 201. The pieces of data that have respectively undergone decompression decoding by the video decoder 202 and the audio decoder 203 are stored in the work memory 103. The pieces of data stored in the work memory 103 are fetched as the need arises during image editing.

The video encoder 204 performs compression encoding on a video stream in accordance with a given moving image recording format, and the compression-encoded video stream is sent to the multiplexing unit 206. Similarly, the audio encoder 205 performs compression encoding on an audio stream in accordance with a given audio recording format, and the compression-encoded audio stream is sent to the multiplexing unit 206.

The multiplexing unit 206 multiplexes a video stream output from the video encoder 204 and an audio stream output from the audio encoder 205 to output an AV stream. The AV stream output from the multiplexing unit 206 is stored in the HDD 104.

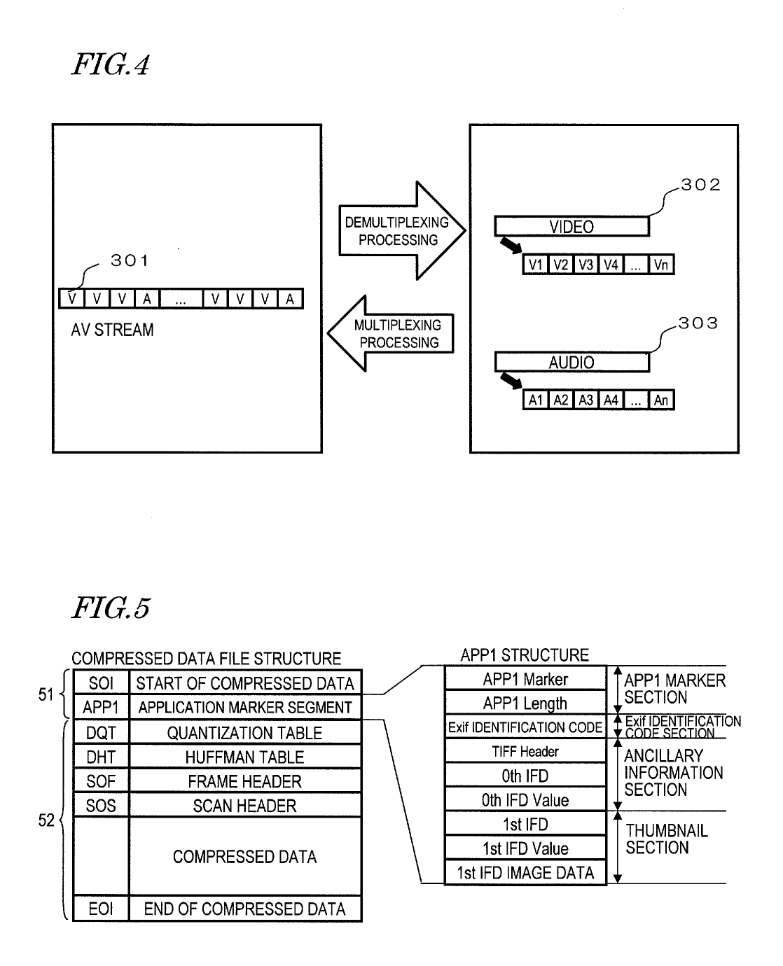

The still image decoder 207 performs decompression decoding on a still image stream that has been compression-encoded. FIG. 4 illustrates how the demultiplexing unit 201 demultiplexes an AV stream into a video stream and an audio stream, and how the multiplexing unit 206 multiplexes a video stream and an audio stream into an AV stream.

An AV stream 301 is a stream obtained by creating a video pack V and an audio pack A in which time information and the like are attached to pieces of given unit data (Vk, Ak) (k=1, 2, . . . n) and multiplexing the video pack and the audio pack into one stream where the packs are played synchronously. The description given here takes as an example a stream that is compatible to video AVCHD®. The demultiplexing unit 201 executes data processing for demultiplexing the AV stream 301 which has been multiplexed into a video elementary stream 302 and an audio elementary stream 303. The multiplexing unit 206 executes data processing for multiplexing the video elementary stream 302 and the audio elementary stream 303 into the AV stream 301.

### 3. Structure of Material Data

Described next is an example of the file structures of a still image and a moving image that are stored in the HDD 104.

The file structure of a still image is described first. FIG. 5 illustrates an example of the file structure of a still image stored in the HDD 104. The description given here on the file structure of the still image takes Exchangeable Image File Format (Exif) as an example.

The still image file illustrated includes a header section 51 and a data recording section 52. The header section 51 stores various types of data for managing the still image file. The header section 51 includes an “SOI” section for storing the start point of compressed data and an “APP1” section for storing an application marker segment. The data recording section 52 includes a “DQT” section for storing a quantization table, a “DHT” section for storing a Huffman table, an “SOF” section for storing a frame header, an “SOS” section for storing a scan header, a section for storing entropy-coded data (compressed data), and a marker code “EOI” which indicates the end of the entropy-coded data.

The “APP1” section in the header section 51 further includes an APP1 marker section, a section for storing an Exif identification code, an ancillary information section, and a thumbnail section. The APP1 marker section further includes a section for storing APP1 data and a section for storing APP1 length data. The ancillary information section further includes a section for storing a TIFF header, a section for storing the 0th IFD, and a section for storing a 0th IFD value. These sections store ancillary information (the photographing date/time, the photographing location, personal identification information, and the like) about an image (main image) represented by the entropy-encoded data. Note that, the main image refers to image data of a normal size, of two types of images (image of normal size and thumbnail image) included in one file in the Exif specification. The thumbnail section includes sections for storing the 1st IFD, a 1st IFD value, and a thumbnail image of the 1st IFD.

The CPU 101 opens the file of an image to be processed as the need arises and obtains a 0th IFD value in the ancillary information section, to thereby grasp ancillary information (the photographing date/time, the photographing location, personal identification information, and the like) about the image. The format of a still image file is not limited to Exif and any format that has ancillary information can be used.

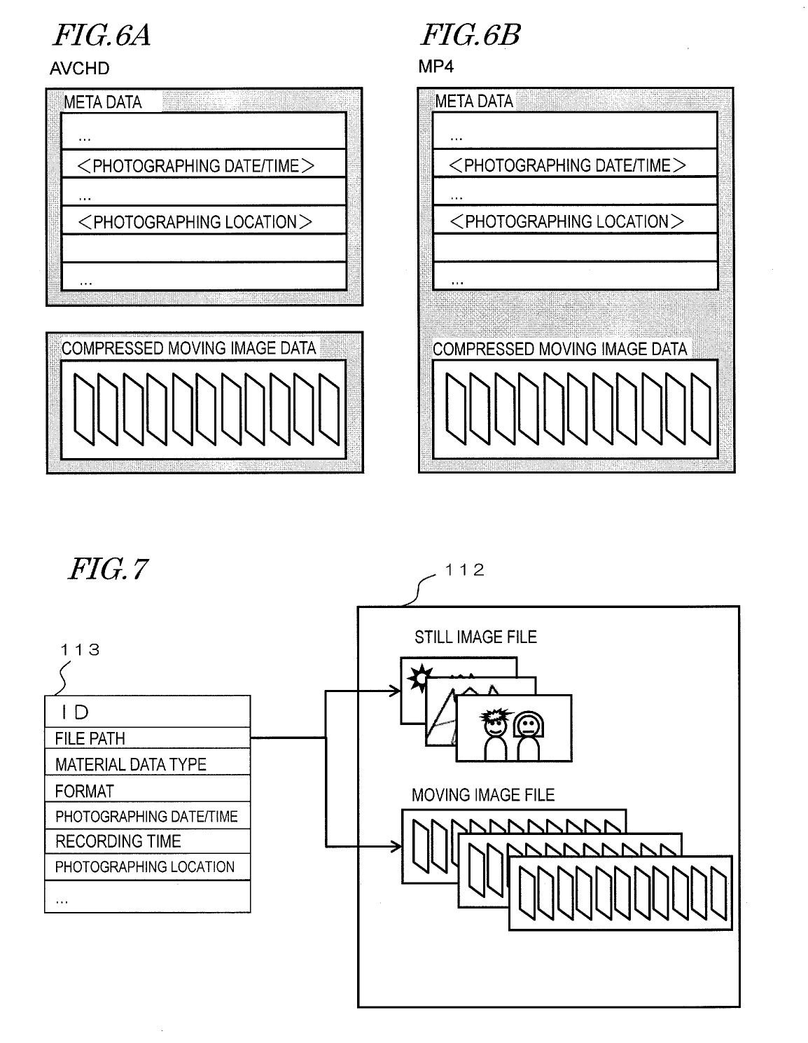

The file structure of a moving image is described next. FIGS. 6A and 6B illustrate examples of the file structure of a moving image stored in the HDD 104.

FIG. 6A illustrates the structure of a moving file image of the AVCHD® format. A moving image file of the AVCHD format uses a file different from that of compressed moving image data to manage meta data. The meta data includes ancillary information (the photographing date/time, the photographing location, personal identification information, and the like) about the image.

FIG. 6B illustrates the structure of a moving file image of the MP4 format. A moving image file of the MP4 format uses the same file for managing compressed moving image data and the meta data. The meta data includes ancillary information (the photographing date/time, the photographing location, personal identification information, and the like) about the image.

The file structure of a moving image in the present invention is not limited to those illustrated in FIGS. 6A and 6B. Specifically, a file structure that stores ancillary information in the compressed image data stream is also employable in the present invention if the CPU 101 can read the ancillary information.

### 4. Database Structure

The PC 100 stores information of material data to be edited in the database 113 within the HDD 104. The structure of the database 113 is described with reference to FIG. 7.

FIG. 7 is a conceptual diagram illustrating the structure of the database 113. As illustrated in FIG. 7, the database 113 holds for each piece of the material data 112 stored in the HDD 104, such as a still image or a moving image, fields for storing an ID, a file path, the type of the material data, the format, the photographing date/time, the length of recording, the photographing location, and the like.

The ID storing field stores a number for uniquely managing the material data. The file path storing field stores information about where in the HDD 104 the material data is saved. The material data type storing field stores information for identifying whether the material data is a still image or a moving image. The format storing field stores the compression encoding format of the material data. The photographing date/time storing field stores information about a date/time at which the material data has been created by photographing a photo or a video. The recording length storing field stores the play time of the material data. The photographing location storing field stores information about the place where the material data has been created by photographing a photo or a video.

The CPU 101 updates the database 113 at the time when the PC 100 newly obtains image data. For example, at the time when a still image or a moving image is newly obtained from a memory card inserted in the card slot 114, or at the time when a still image or a moving image is newly obtained from another storage device via the USB connector 107, the CPU 101 opens the file of the obtained image. The CPU 101 updates the database 113 by reading ancillary information out of the opened image file and adding the read information in the storing fields of the database 113 that are associated with the ancillary information.

### 5. Selection Screen Configuration

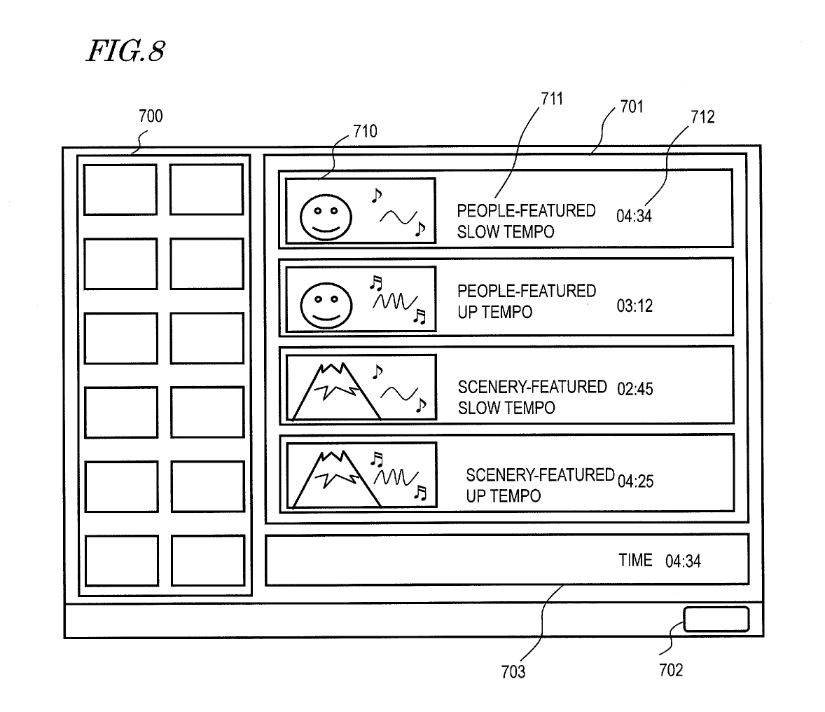

The configuration of a selection screen displayed on the liquid crystal display 109 is described next with reference to FIG. 8. FIG. 8 is a diagram illustrating an example of a selection screen that the liquid crystal display 109 controlled by the graphics controller 108 displays upon instruction from the CPU 101.

As illustrated in FIG. 8, the selection screen displayed on the liquid crystal display 109 includes a material selection area 700, a template selection area 701, a play time display area 703, and an “execute” button 702.

The material selection area 700 is an area in which material data to serve as a material for creating conte data is displayed. An individual piece of material data to serve as a material is still image data or moving image data. The material selection area 700 displays a plurality of pieces of material data as illustrated in FIG. 8.

Material data displayed in the material selection area 700 may be all of material data stored in the HDD 104, or may be selectively extracted material data which is stored in a specific folder. Alternatively, the displayed material data may be material data further selected by the user from among material data stored in a specific folder. The material data displayed in the material selection area 700 is a candidate for an image that is incorporated in a conte being created.

The material selection may be implemented by, for example, providing a “select material” button in the material selection area 700 so that the user's press of this button causes a transition to a screen for selecting a material, or by adding or deleting an image file with drag-and-drop.

The material selection area 700 may be designed in a manner that allows the user to set, to each piece of material data displayed in the material selection area 700, a priority level as material data to be incorporated in conte data. In this case, material data to which a high priority level is set can be selected preferentially when it is not possible to employ all of material data (as in the case where the play time is short). Conte data that employs images that the user wants to use is thus created.

The template selection area 701 is an area for displaying templates that can be selected by the user. A template is information describing what displaying effects are sequentially arranged in what order when creating a story. The template describes for each displaying effect that is numbered how long a play time is allocated. The CPU 101 follows the order of displaying effects that is described in the template in arranging materials that are selected by a given algorithm from candidate material data selected by the user.

Templates that can be selected by the user are, for example, ones illustrated in FIG. 8 which are a “people-featured slow-tempo template”, a “people-featured up-tempo template”, a “scenery-featured slow-tempo template”, and a “scenery-featured up-tempo template”. The respective templates are outlined as follows:

(1) “People-Featured Slow-Tempo Template”

A template describing a story for which images capturing people are mainly extracted and image dramatizing effects suitable for a slow-tempo BGM are used.

(2) “People-Featured Up-Tempo Template”

A template describing a story for which images capturing people are mainly extracted and image dramatizing effects suitable for an up-tempo BGM are used.

(3) “Scenery-Featured Slow-Tempo Template”

A template describing a story for which images capturing scenery are mainly extracted and image dramatizing effects suitable for a slow-tempo BGM are used.

(4) “Scenery-Featured Up-Tempo Template”

A template describing a story for which images capturing scenery are mainly extracted and image dramatizing effects suitable for an up-tempo BGM are used.

Each template display area of the template selection area 701 displays an image 710, which represents an image of the template, a template name 711, and a BGM play time 712, which is a default setting of the template. The user can select a desired template from a plurality of types of templates by operating the mouse 105. By preparing a plurality of types of templates as described above, the user can change the current template to another template to change the atmosphere of a story to be created. The template types are not limited to the example given above, and more different types of templates may be prepared.

The play time display area 703 is an area for displaying the play time of a movie to be created. In this embodiment, the play time of the movie is set to the play time of a default BGM which is set in each template. Selecting a template determines a default play time. The screen may be provided with an area for setting a play time in order to allow the user to directly set the movie play time. Alternatively, a function of changing the BGM to be played along the movie to a desired BGM may be provided so that, by changing the set BGM to another BGM, the play time of the new BGM is set as the play time of the movie.

With the configuration described above, even a beginner can easily execute material data selecting processing, displaying effect rendering processing, and story creating processing that takes the overall flow into consideration in a manner that fits the movie within a specified play time.

The “execute” button 702 is a button for completing the selection of material data to serve as candidates for conte creation and of a template. When the user operates the mouse 105 and presses the “execute” button 702, conte data is created based on material data that has been selected in the material selection area 700 and a template that has been selected in the template selection area 701. Details of the flow of this conte data creating operation are described later.

### 6. Preview Screen Configuration

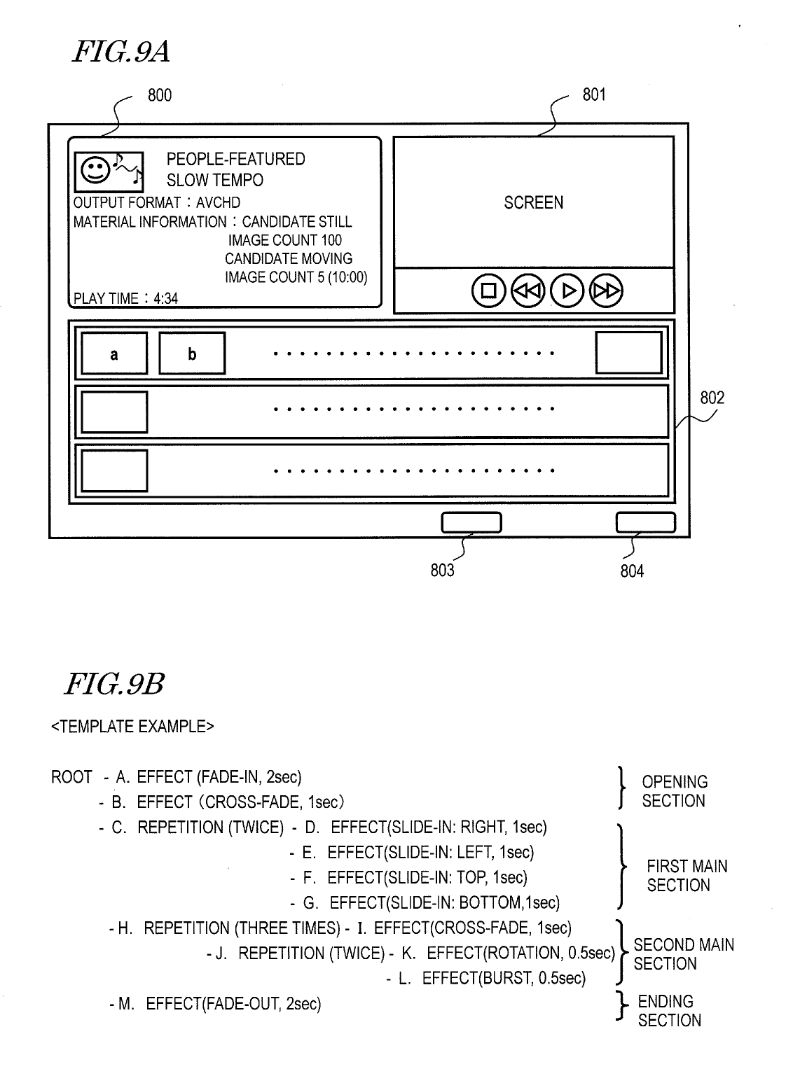

The configuration of a preview screen displayed on the liquid crystal display 109 is described next with reference to FIG. 9A. FIG. 9A is a diagram of the imagery of a preview screen, which is displayed on the liquid crystal display 109 after the “execute” button 702 of FIG. 8 is pressed. As illustrated in FIG. 9A, the preview screen displayed on the liquid crystal display 109 includes a conte information display area 800, a preview area 801, a storyboard area 802, a “save conte data” button 803, and an “output file” button 804.

The conte information display area 800 is an area for displaying information about items selected by the user on the selection screen. In an example illustrated in FIG. 9A, the displayed information includes the count of selected material data, the selected template name, the play time, and information of output format. The count of selected material data refers to the count of still images and the count of moving images to be incorporated in the conte data.

The count of still images and moving images that is displayed here is not limited to the count of actually used images, and may be the count of particularly prominent images. For example, an image that is displayed for a time shorter than a given length of time and an image that is smaller than a given size may not be counted. These image counts are calculated by the CPU 101 based on the specified template and play time. In the case where the count of candidate images selected by the user is lower than the count of used images which is calculated based on the template and the play time, some of the images are used twice or more. An image used twice or more is not counted as one image, but is counted repeatedly as many times as the number of times the image is used. Though not illustrated, the conte information display area 800 may additionally display the count of actually employed still images and the count of actually employed moving images. This way, the user can check how many of candidate images are actually employed.

The preview area 801 is a screen where the created conte is played. The user can actually check the specifics of the created conte data in the form of a video.

The storyboard area 802 is an area for displaying the specifics of the created conte data. In the storyboard area 802, a plurality of rectangles (a, b, . . . ) are aligned in an order that corresponds to the display order in the conte data. Each rectangle displays one of images extracted from images that have been displayed in the material selection area 700. Though not illustrated, the storyboard area 802 may additionally display an icon that represents an effect of a switch between video images. Alternatively, the storyboard area 802 may additionally display the play time for playing a partial video (scene) that corresponds to each rectangle. This way, the user can check which material data is arranged in what order in the story to be played with what effects for how long play time.

The rectangles in the storyboard area 802 respectively correspond to individual scenes constituting the movie. Each scene is made up of one or more images. A scene made up of a plurality of images may be called herein as a “group scene” whereas a scene made up of a single image may be called as a “non-group scene”. Each group scene is made up of a plurality of images that are assumed to be highly correlated to one another. For example, a group scene can be constituted of a plurality of images that have close photographing dates and times, a plurality of images that have close photographing locations, or a plurality of images that share a common subject. Group scenes are given dedicated displaying effects which differ from displaying effects of non-group scenes. For instance, a group scene may be given a displaying effect in which a plurality of images are displayed simultaneously and at least some of the displayed images shift, rotate, or increase or decrease in size. A non-group scene, on the other hand, may be given a displaying effect in which a single image shifts, rotates, or increases or decreases in size. Details of these displaying effects are described later.

When one scene switches to another scene, group scenes and non-group scenes are both given switching effects that are defined in the template in advance. Examples of the switching effects include slide-in, cross-fade, rotation, and burst. Effects rendered to respective scenes, including these switching effects, are called herein as “displaying effects”.

The “save conte data” button 803 is selected by operating the mouse 105. The user can press the “save conte data” button 803 to save in the HDD 104 story information for managing which material data is arranged in what order to be played with what displaying effect for how long play time. Though not illustrated, a “read conte data” button may be provided in a screen of an upper hierarchy level, for example, the selection screen of FIG. 8, so that previously saved conte data can be read.

The “output file” button 804 is selected by operating the mouse 105. The user can press the “output file” button 804 to create a moving image file based on the created conte data. Specifically, the CPU 101 creates a moving image file by operating the video encoder 204, the audio encoder 205, and the multiplexing unit 206 as described above. The output format of the created moving image file may be selected by the user in advance. In other words, when the user has selected the AVCHD® file format, a moving image file of the AVCHD file format is created. As stated above, the moving image file format in the present invention is not limited to the AVCHD file format and may have MP4 or other formats.

The screen layouts of FIGS. 8 and 9 are an example, and an arbitrary screen layout can be used as long as the same functions are implemented.

### 7. Template Configuration Information

An example of concrete information written in a template is described next. FIG. 9B is a diagram illustrating an example of a hierarchical structure that is written in a template according to this embodiment.

As described above, a template is information defining what switching effects are arranged into a sequence in what order to create a story. For each of the switching effects arranged in an order, the template describes how long a play time is to be allotted. The CPU 101 places selected materials in a sequence in accordance with the order of switching effects written in a template. As illustrated in FIG. 9B, templates in this embodiment have a tree structure made up of “repetition nodes” and “effect nodes”. Each effect node corresponds to an individual scene.

The template of FIG. 9B has an opening section, a first main section, a second main section, and an ending section. While this embodiment takes as an example a case where two main sections, the first main section and the second main section, are included, a template may have only one main section or three or more main sections.

The opening section, the first main section, the second main section, and the ending section are each constituted of an “effect node” and/or a “repetition node”, which has one or more effect nodes. An effect node has scene play time information and information indicating the type of a switching effect. A repetition node can have as a child node an effect node and/or another repetition node, whereas an effect node cannot have a child node. The CPU 101 displays images in accordance with play times and switching effects defined by the respective effect nodes. A repetition node has information for repeating an effect node and/or another repetition node that belongs to the repetition node a specified number of times (repetition count information). A repetition node repeats a series of nodes (Child Node 1, Child Node 2, . . . Child Node n) designated as child nodes of the repetition node in order a plurality of times. To repeat once, the display order is “(Child Node 1)→(Child Node 2)→ . . . →(Child Node n)”. To repeat twice, the display order is “(Child Node 1)→(Child Node 2)→ . . . →(Child Node n)→(Child Node 1)→(Child Node 2)→ . . . →(Child Node n)”.

The opening section is written so that the play time per image is rather long in order to allow the user to superimpose title text of the story on an image. In the example of FIG. 9B, the opening section is configured so that 2 seconds of “A. fade-in” effect is followed by 1 second of “B. cross-fade” effect. In the case where each scene of the opening section is constituted of only one image, two images are used in the opening section. Specifically, the first image is inserted by the “A. fade-in” effect to a black screen being displayed on the liquid crystal display 109, and the second image is inserted to the screen by the “B. cross-fade” effect two seconds after the first image.

The first main section and the second main section, where main images of the story are placed, are written so that switching effects that build up are set. The switching effect set to the second main section which is a climax is showier than the one set to the first main section. In the example of FIG. 9B, the first main section has as child nodes four switching effects, which are 1 second of “D. slide-in: right” effect, 1 second of “E. slide-in: left” effect, 1 second of “F. slide-in: top” effect, and 1 second of “G. slide-in: bottom” effect. The first main section is constituted of a repetition node C for repeating these four child nodes, and the repetition count is initially set to twice. The second main section is constituted of a repetition node H of which the repetition count is set to three times and which includes a child effect node and a child repetition node. The child effect node has 1 second of “I. cross-fade” effect. The child repetition node is a repetition node J for repeating, twice, two grandchild nodes, one of which has 0.5 seconds of “K. rotation” effect and the other of which has 0.5 seconds of “L. burst” effect. The repetition node H repeats the child effect node and the repetition node J three times.

The ending section, where images that wrap up the story are placed, is set so that the play time per image is relatively long. In the example of FIG. 9B, the ending section is constituted of an image that has 2 seconds of “M. fade-out” effect.

In the case where a story is created with the repetition counts set to the initial settings of the template of FIG. 9B as described above, the order of the effect nodes is “(A. fade-in: 2 sec)→(B. cross-fade: 1 sec)→(D. slide-in: right: 1 sec)→(E. slide-in: left: 1 sec)→(F. slide-in: top: 1 sec)→(G. slide-in: bottom: 1 sec)→(D. slide-in: right: 1 sec)→md (E. slide-in: left: 1 sec)→(F. slide-in: top: 1 sec)→(G. slide-in: bottom: 1 sec)→(I. cross-fade: 1 sec)→(K. rotation: 0.5 sec)→(L. burst: 0.5 sec)→(K. rotation: 0.5 sec)→(L. burst: 0.5 sec)→(I. cross-fade: 1 sec)→(K. rotation: 0.5 sec)→(L. burst: 0.5 sec)→(K. rotation: 0.5 sec)→(L. burst: 0.5 sec)→(I. cross-fade: 1 sec)→(K. rotation: 0.5 sec)→(L. burst: 0.5 sec)→(K. rotation: 0.5 sec)→(L. burst: 0.5 sec)→(M. fade-out: sec)”. These display times add up to 22 seconds. The templates thus have a tree structure made up of repetition nodes and effect nodes.

In the case where the user specifies a length of time longer or shorter than a default total play time set in a template, the CPU 101 may execute processing that fits the total play time to the length of time specified by the user. For example, the CPU 101 can adjust the total play time to the length of time specified by the user by increasing or decreasing the repetition counts of some of repetition nodes included in the template that have lengths suitable for the adjustment.

The template configuration described above is merely an example, and the present invention is not limited to configurations that use a template as the one described above. The above example discusses only switching effects as displaying effects given to the respective scenes for simplicity, but other displaying effects than switching effects can be rendered as described later. Other displaying effects than switching effects, which are written in data that is not a template in this embodiment as described later, may be written in a template.

### 8. Conte Data Creating Operation

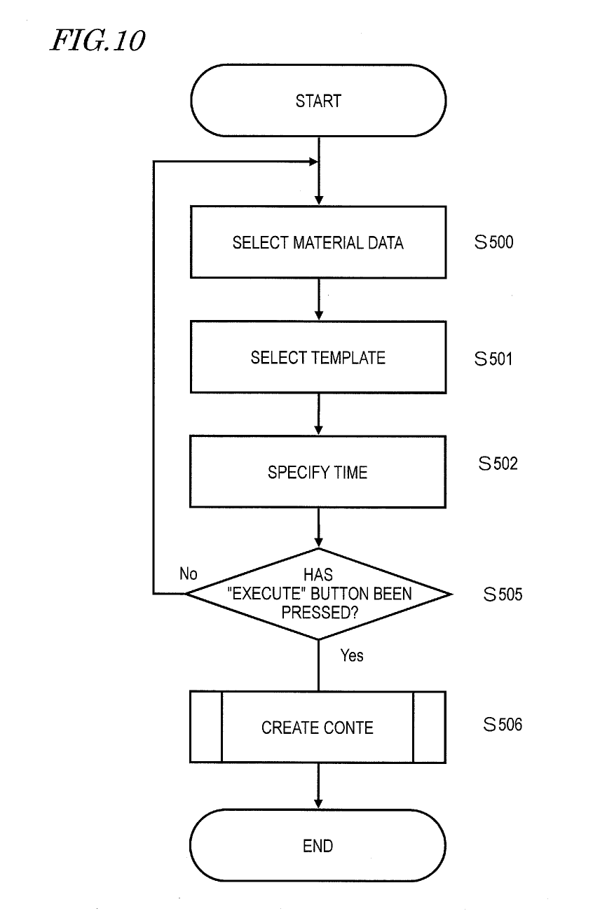

Described next is a procedure of creating a conte data based on selected materials, a selected template, and a selected BGM. FIG. 10 is a flow chart outlining story creating processing in this embodiment.

The user first selects material data (candidate images) to be candidates for the creation of a conte (S500). When material data is selected, the CPU 101 displays the selected material data in the material selection area 700. The user may further set priority levels as described above.

The user next selects a template to be used for the creation of the conte (S501). When the template is selected, the CPU 101 highlights the selected template in the template selection area 701. The user next determines whether or not to employ the default play time of the selected template in the creation of a conte. In the case where the default play time of the selected template is not employed, the user specifies an arbitrary length of time (S502). The user may directly specify a length of time, or may select a desired BGM to set the play time of the BGM as the total play time of the movie. The operations of Steps S500 to S502 may be executed in a different order.

After selecting material data and a template and specifying a play time that are to be used in the creation of a conte, the user presses the “execute” button 702 to enter the selected items (S505). The CPU 101 then creates a conte using the selected items (S506).

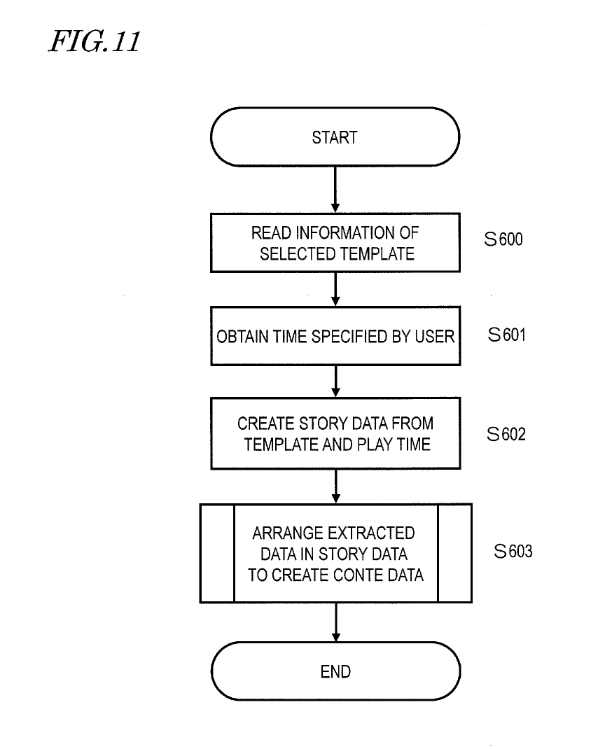

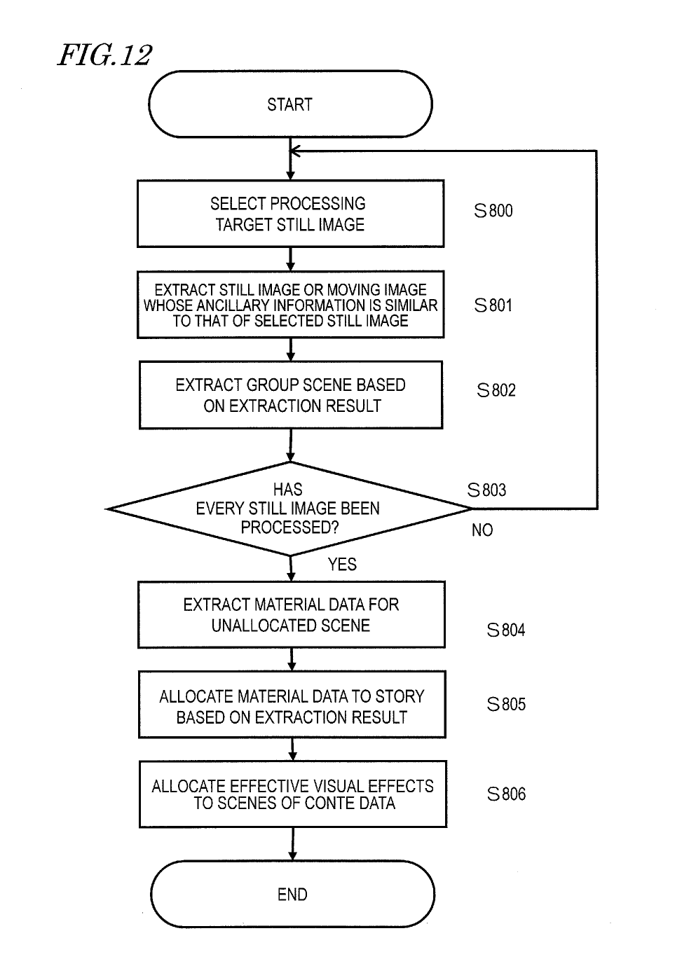

Details of the conte creation in Step S506 are described next. FIG. 11 is a main flow chart of conte data creating operation for story data according to this embodiment, in which images that are assumed to be important to the user are extracted from among pieces of material data (still images and moving images) selected by the user, and video parts constituted of the extracted images are arranged in an effective manner.

The CPU 101 first reads information of the template selected in Step S501 (S600). The CPU 101 next obtains the play time specified by the user in Step S502 (S601).

The CPU 101 then creates story data in accordance with story information described in the template, in a manner that fits the movie within the default play time defined in the template or the play time specified by the user (S602). The story data created by the CPU 101 describes both the display times of video images of the respective scenes arranged in sequence and displaying effects rendered to video images of the respective scenes and to switches between video images. The story data is data describing a plurality of scenes, which are determined based on the specified template and the total play time, and the displaying effects associated with the plurality of scenes on the time axis.

The CPU 101 next creates conte data based on the story data created in Step S602, by arranging in an effective manner video images of scenes made up of images that are extracted from among the pieces of material data selected by the user, that satisfy conditions of the template, and that are assumed to be important to the user (extracted data) (S603). The conte data is data obtained by adding, to the information included in the story data, information on the images (important images) included in the scenes and the displaying effects rendered to the images.

Details of the conte data creating operation in Step S603 are described next with reference to FIG. 12. FIG. 12 is a flow chart illustrating details of the processing of creating conte data by arranging the extracted data in the story data.

The PC 100 according to this embodiment selects, as a reference of the processing, one still image after another from among the pieces of material data selected by the user. Hereinafter, this still image may be called as a “processing target still image”. The PC 100 extracts segments of a moving image that have been photographed within a given time period before and after the photographing time of the processing target still image, and extracts still images that have been photographed within the given time period before and after the photographing time of the processing target still image. A combination of an extracted still image and an extracted moving image segment is edited as the same group scene. Similarly, a combination of an extracted still image and another extracted still image is edited as the same group scene. The processing reference, which is a still image in this embodiment, may instead be a moving image.

The CPU 101 selects as the processing target one still image from among the pieces of material data included in the material selection area 700 (S800). The CPU 101 reads ancillary information about the processing target still image. This ancillary information is, as described with reference to FIG. 7, stored in given storing fields of the database 113. The CPU 101 obtains the ancillary information of the current processing target still image by reading the database 113.

The CPU 101 next reads ancillary information about still images or moving images other than the processing target still image. This ancillary information, too, is stored in given storing fields of the database 113, and the CPU 101 obtains the ancillary information of still images or moving images other than the processing target still image by reading the database 113.

The CPU 101 next extracts still images or moving images that are not the processing target and that have ancillary information similar to the obtained ancillary information of the processing target still image (S801). Based on the processing target still image and the extracted still images or moving images, the CPU 101 extracts a group scene (S802). The processing described above is executed repeatedly until every still image is processed (S803).

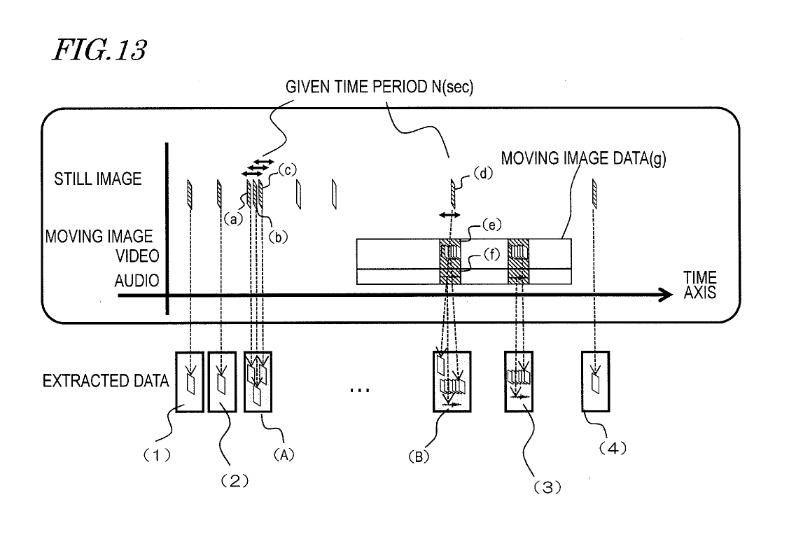

FIG. 13 is a conceptual diagram illustrating the group scene extracting processing based on photographing date/time in Step S802. In the PC 100 according to this embodiment, the CPU 101 extracts, from among extracted still images or moving images, as images that constitute a group scene, still images or moving images that are not the processing target and that have been photographed within a given time period N (sec) with respect to the photographing date/time of the processing target still image as the reference.

A group scene (A) of FIG. 13 is a group scene formed by extracting, with a processing target still image as the reference, still images that are not the processing target and that have been photographed within the given time period N (sec) from the photographing date/time of the processing target still image. Specifically, when a still image (a) is the reference, a still image (b) is within the given time period N (sec) and the CPU 101 extracts the still image (a) and the still image (b) as the same group scene. When the still image (b) is the reference, the CPU 101 extracts as the same group scene the still image (a), the still image (b), and a still image (c), which are within the given time period N (sec). Similarly, when the still image (c) is the reference, the CPU 101 extracts as the same group scene the still image (b) and the still image (c), which are within the given time period N (sec). In this case, the group scene does not include the still image (c) when the still image (a) is the reference, and the group scene similarly does not include the still image (a) when the still image (c) is the reference. When the still image (b) is the reference, on the other hand, the group scene includes both the still image (a) and the still image (c). Accordingly, the CPU 101 links by association 1) a still image that is included in the same group scene as one processing target still image and 2) another still image that is extracted as an image belonging to the same group scene as the former still image when the former still image is used as the reference, and the CPU 101 extracts all these still images as the same group scene. However, a threshold may be provided to limit how many still images can be linked by association. In the case where the threshold is provided, the CPU 101 keeps the count of still images that are extracted as images included in the same group scene within a range indicated by the set threshold. The CPU 101 thus extracts the still image (a), the still image (b), and the still image (c) as the group scene (A) in Steps S800 to S803.

A group scene (B) represents a group scene that is extracted when a still image (d) is the processing target. The CPU 101 extracts, from the entire stream of a moving image (g), which is not a processing target, a video stream segment (e) and an audio stream segment (f) in a part of the stream that has been photographed within the given time period N (sec) from the photographing date/time of the processing target still image (d). The video stream segment (e), the audio stream segment (f), and the still image (d) constitute the group scene (B). The CPU 101 may extract stream segments longer than the length of a part of a moving image that is actually employed in conte data in order to create margin for the editing of the moving image when visual effects are allocated to scenes of conte data in an effective manner by processing described later. Specifically, when the still image (d) is used as the reference as illustrated in FIG. 13, the CPU 101 determines that the photographing period of the moving image data (g) includes the photographing period of the still image (d). The CPU 101 then extracts a part of the stream of the moving image data (g) that has been photographed within the given time period N (sec) from the photographing date/time of the still image (d), namely, a partial stream (one segment of a moving image) that is constituted of the video stream segment (e) and the audio stream segment (f). The example here shows a case where the photographing period of the moving image data (g) includes the photographing date/time of the still image (d). However, when the photographing period of moving image data does not include the photographing date/time of a processing target still image, too, the moving image data may be extracted as an image belonging to the same group scene if the moving image data includes a segment that has been photographed within the given time period N (sec) from the photographing date/time of the processing target still image. The CPU 101 thus extracts the still image (d) and the video stream segment (e) and the audio stream segment (f), which constitute a partial stream of the moving image data (g), as the group scene (B) in Steps S800 to S803.

A plurality of images belonging to the same group are extracted with a still image as the reference (the processing target) in the example described above, but the same processing may be performed with a moving image as the processing target. In other words, moving images or still images that have been photographed near the photographing date/time of a moving image used as the reference may be treated as the same group. Alternatively, a period in which a moving image has been photographed may be identified from the photographing date/time and play time of the moving image to set other still images and other moving images that have been photographed within the identified period as the same group.

With a conventional photo movie creating device, a user who wants to select a moving image as a material has no way of selecting a desired scene without checking the contents of the entire stream of the moving image. According to this embodiment, on the other hand, moving images and still images are automatically extracted as a group scene as described above, and the user can therefore incorporate a desired scene in a movie more easily.

Referring back to FIG. 12, the CPU 101 determines whether or not the group scene extraction has been completed for every still image included in the material selection area 700 (S803). When it is determined in Step S803 that the group scene extraction has not been completed, the CPU 101 repeats the operations of Steps S800 to S803 for every still image that is included in the material selection area 700. When it is determined in Step S803 that the group scene extraction has been completed, the operation of the CPU 101 proceeds to Step S804.

The CPU 101 knows the count of scenes to be placed in the story. Therefore, after the group scene extraction is completed, the CPU 101 can figure out how many of the scenes to be placed in the story have already been allocated. The CPU 101 can also figure out how many of the scenes to be placed in the story are not allocated yet at this point. The CPU 101 determines an image that constitutes a non-group scene by extracting material data to be placed in the story for scenes to which video images have not been allocated (S804). The CPU 101 extracts materials to be used under the following conditions:

Condition 1: Selecting materials so that the selected materials are distributed evenly throughout the photographing date/time span of the entire materials (still images and moving images).

Condition 2: In the case where a people-featured template is selected, preferentially selecting images in which the main subject is a person.

Condition 3: In the case where a scenery-featured template is selected, preferentially selecting images in which the main subject is a scenery.

Condition 4: In the case where priority levels are set to images displayed in the material selection area 700 in Step S500, preferentially selecting images that have high priority levels.

Whether the main subject of an image is a person or a scenery can be determined based on the characteristics of the image by using a known method. The CPU 101 may execute this determination each time conte data is created, or may refer to, when creating conte data, information that is stored in the database 113 in advance for each image to indicate what the main subject of the image is.

The CPU 101 takes into account the conditions described above to extract a non-group scene (1), a non-group scene (2), a non-group scene (3), and a non-group scene (4) as illustrated in FIG. 13. The CPU 101 then ends the operation of extracting material data to be allocated to the story.

Based on the result of the extraction, the CPU 101 allocates material data to the story to create conte data (S805).

After finishing the operation of Step S805, the CPU 101 allocates effective displaying effects (visual effects) respectively to the extracted group scenes and non-group scenes (S806). The CPU 101 allocates to a non-group scene a visual effect that is defined in the template as it is. To a group scene, on the other hand, the CPU 101 allocates a visual effect characteristic to the group scene by using a still image, a video stream segment, and an audio stream segment that constitute the group scene.

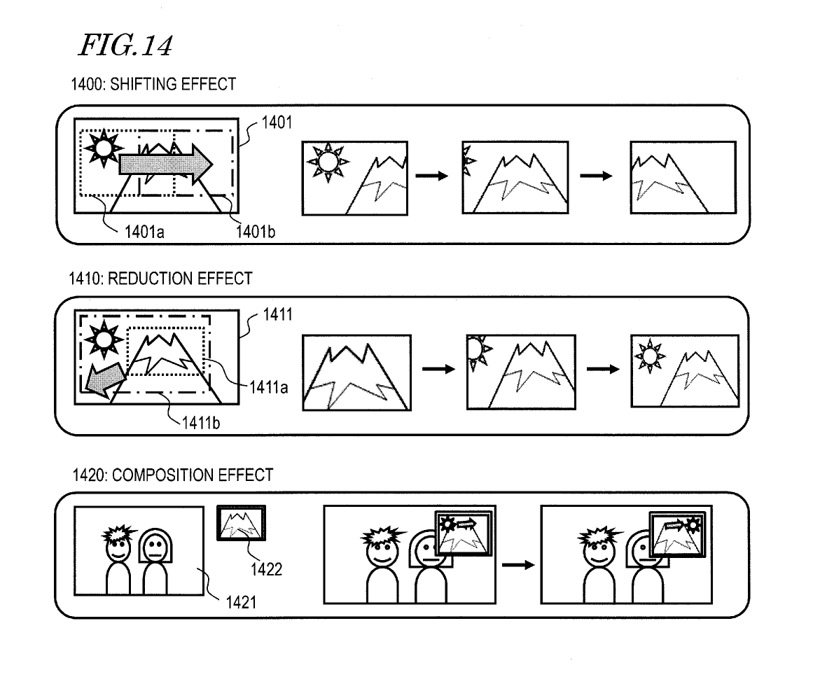

Visual effects allocated to the respective scenes in Step S806 are described below. FIG. 14 is an imagery diagram illustrating an example of the visual effects.

A shifting effect 1400 is a visual effect that simulates the panning action in camera work using an image 1401. The CPU 101 creates a video that shifts from a start point 1401a of the image 1401 to a finish point 1401b over a given length of time, thereby simulating panning from the left to the right. The image 1401 can be a still image or a video stream. The direction of the shift can be any one of the upward direction, the downward direction, the leftward direction, and the rightward direction. This effect is applicable to group scenes and non-group scenes both.

A reduction effect 1410 is a visual effect that simulates the zooming out in camera work using an image 1411. The CPU 101 creates a video that zooms out over a given length of time from an initial state 1411a of the image 1411 to a final state 1411b, thereby presenting a view that gradually expands from the center of the screen to the whole screen. In this example, too, the image 1411 can be a still image or a video stream. The initial state and the final state may be switched to simulate zoom-in (an enlarging effect) in camera work. This effect is applicable to group scenes and non-group scenes both.

A composition effect 1420 is a visual effect that superimposes a plurality of images by using an image 1421 and an image 1422. The CPU 101 creates a video of a given length of time that places the image 1421 and the image 1422 in the same display area (screen), thereby presenting a sight of a plurality of superimposed images. The images 1421 and 1422 each can be a still image or a video stream. This effect uses a plurality of images and is therefore applicable to only group scenes.

The CPU 101 may allocate to a group scene the shifting effect 1400, reduction effect 1410 (or expansion effect), and composition effect 1420 described above alone or in combination. For example, a group scene may be allocated the composition effect 1420 while at least some of the images of the group scene are also allocated at least one of the reduction effect 1410, the expansion effect, and the composition effect 1420. Alternatively, a group scene may be allocated the effects described above while at least some of the images of the group scene are also allocated displaying effects that cause the images to perform complicate actions such as rotation and burst.

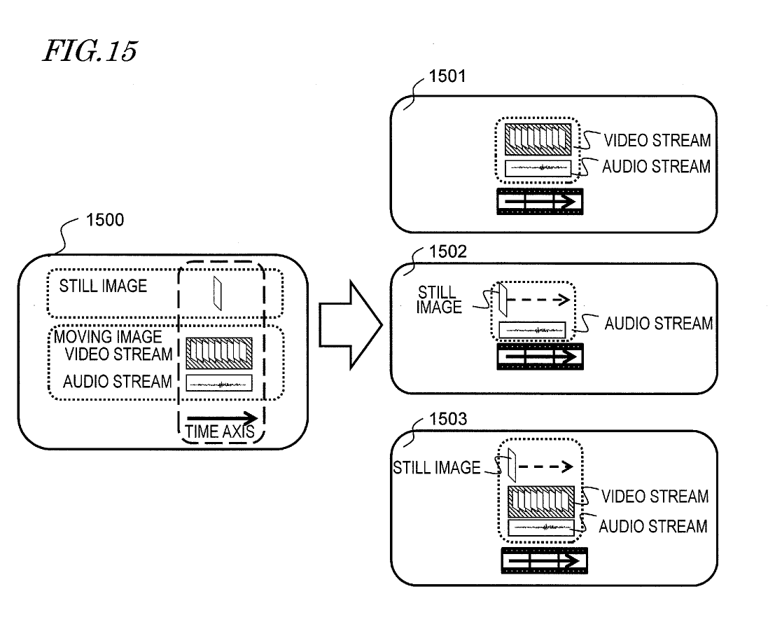

The concept of giving a displaying effect to a group scene in Step S806 is described next. FIG. 15 is a conceptual diagram of data sets in a group scene extracted in Step S806.

A group scene 1500 is an example of group scenes extracted in the operations of Steps S800 to S803. The group scene 1500 is constituted of one still image and one segment of a moving image (a video stream segment and an audio stream segment).

A data set 1501, a data set 1502, and a data set 1503 which are illustrated in FIG. 15 are the concept of data sets selected from the group scene 1500. In the group scene 1500, one of the data sets 1501, 1502, and 1503 is employed in video images of an actual scene.

The data set 1501 is a data set that uses, out of the components of the group scene 1500, the video stream segment and the audio stream segment but not the still image. In the case where the data set 1501 is employed, the video stream segment and the audio stream segment are used whereas the still image is not used. The video stream segment and audio stream segment to be used have been photographed near the photographing date/time of the still image. The fact that the still image and the moving image have been photographed at dates and times close to each other suggests a strong possibility that a subject captured in the moving image is important to the user. Consequently, when the data set 1501 is employed, the still image is used as a cue for extracting a part of the moving image stream that has captured a subject important to the user.

A data set 1502 is a data set that uses, out of the components of the group scene 1500, the still image and the audio stream segment but not the video stream segment. In the case where the data set 1502 is employed, only the still image and the audio stream segment are used in video images of an actual scene. For example, applying an effect such as the shifting effect 1400 or the reduction effect 1410 to a high resolution still image embellishes the video by combining a pretty visual scene with a realistic sound. The illustrated example includes just one still image. In the case where another still image is included in the same group scene, a plurality of still images included in the same group scene may be used for a shared audio stream segment.

The data set 1503 is a data set that uses all of the components of the group scene 1500, namely, the still image, the video stream segment, and the audio stream segment. In the case where the data set 1503 is employed, the still image, the video stream segment, and the audio stream segment are all used in video images of a scene. For example, the composition effect 1402 is applied to display a high resolution still image and a video stream segment depicting motion concurrently, and the audio stream segment is played while the shifting effect 1400, the reduction effect 1401, or the like is further applied to the high resolution still image. A video containing a larger volume of information can thus be expressed.

The data sets are not limited to the example described above and may include, for example, a data set that includes a plurality of still images and a data set that includes a plurality of moving images. A data set that includes no still image and a data set that includes no moving image may also be included.

The CPU 101 determines which data set is to be used based on what is written in the specified template or the result of image analysis. Examples of image analysis result include the degree of camera shake and how out of focus the image is. For example, in the case where the still image is not favorable in terms of the degree of camera shake and how out of focus the image is, whereas video data that is included in the same group scene is favorable in terms of the degree of camera shake and how out of focus the video data is, the CPU 101 may employ the data set 1501. In the opposite case where the video data is not favorable in terms the degree of camera shake and how out of focus the video data is, the CPU 101, whereas the still image that is included in the same group scene is favorable in terms of the degree of camera shake and how out of focus the image is, the CPU 101 may employ the data set 1502.

The CPU 101 allocates displaying effects as the ones illustrated in FIG. 14 to the employed data set. The data set type and specifics of displaying effects to be given may vary from scene to scene, or common displaying effects may be given to a plurality of scenes. In this manner, the CPU 101 arranges extracted data (which may be a data set, a still image alone, or a part of a moving image alone) in story data to create conte data. The CPU 101 can save story information of the created conte data and output a moving image file of the created conte data in a specified file format.

The CPU 101 can extract as the same group scene another still image or a part of a moving image that has been photographed near the photographing date/time of a processing target still image in the manner described above. In other words, the CPU 101 can easily and effectively extract a scene suitable for conte data editing, with the processing target still image as a cue. This facilitates the work of extracting still images or moving images to be employed when the user performs a conte data editing operation. The CPU 101 can also allocate a suitable displaying effect to each group scene because still images and moving images have been extracted as group scenes.

### 9. Other Embodiments

The present invention is not limited to the first embodiment described above, and can be carried out in other modes. Descriptions on other embodiments are all given below.

The embodiment described above deals with a case in which the photographing date/time is used as ancillary information of still images or moving images, but the present invention is not limited thereto. Specifically, the photographing location or personal identification information may be used as ancillary information of still images or moving images. The operations of Steps S800 to S803 in the flow chart of FIG. 12 may use the photographing location or personal identification information as ancillary information. Similarly, the operation of Step S806 in the flow chart of FIG. 12 may use the photographing location or personal identification information as ancillary information.

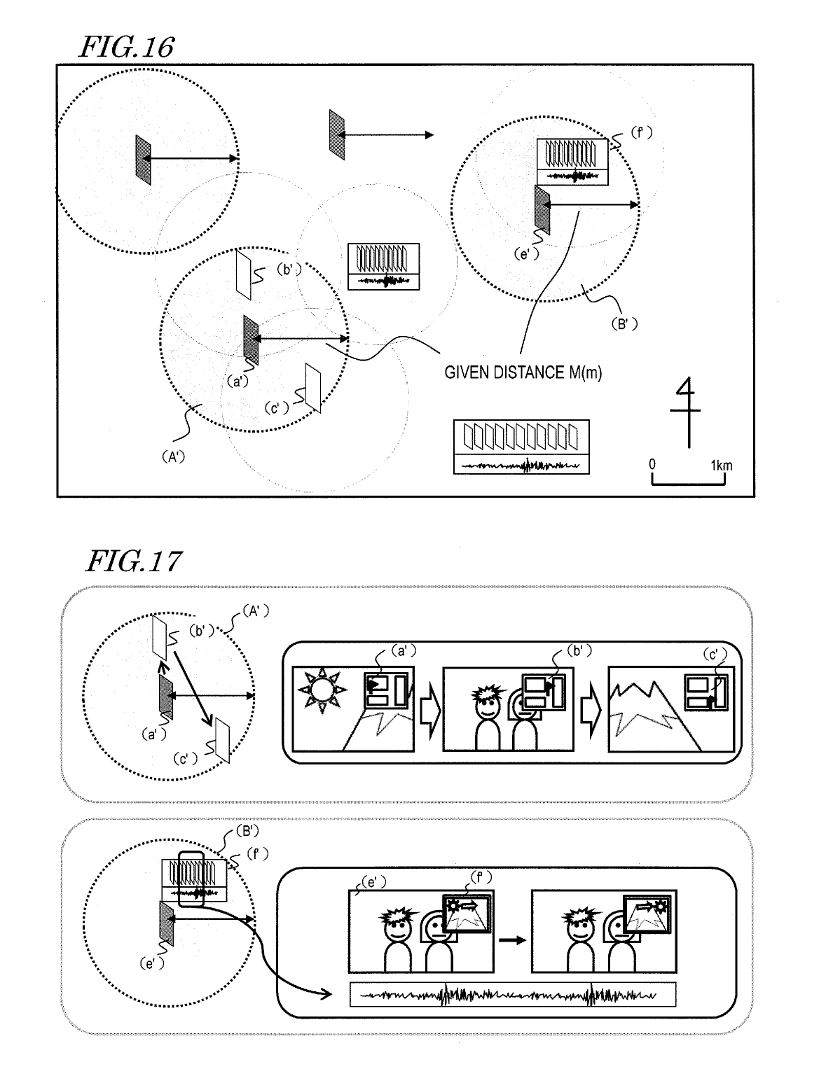

FIG. 16 is a conceptual diagram illustrating how group scenes are extracted when the operations of Steps S800 to S803 in the flow chart of FIG. 12 use the photographing location as ancillary information. FIG. 16 illustrates an example in which a plurality of still images and moving images are plotted at points on a map that correspond to the images' photographing locations. In the PC 100 according to this embodiment, the CPU 101 uses the photographing location of a processing target still image as the reference to extract, as a group scene, still images or moving images that are not the processing target and that have been photographed within a given distance M (m) from the reference.

In the example of FIG. 16, a group scene (A′) is a group scene that includes a still image (b′) and a still image (c′) which are not the processing target and which have been photographed within the given distance M (m) from the photographing location of a processing target still image (a′) serving as the reference. In other words, when the still image (a′) is the reference, the still image (b′) and the still image (c′) are within the given distance M (m), and the CPU 101 therefore extracts the still image (a′), the still image (b′), and the still image (c′) as components constituting the same group scene (A′) in Steps S800 to S803. In this case, a group scene that has the still image (b′) as the reference does not include the still image (c′). Similarly, a group scene that has the still image (c′) as the reference does not include the still image (b′). However, as in the case described in the first embodiment where group scene extraction is based on the photographing date/time, still images are linked by association to be extracted as the same group scene. In this case, too, it is preferred to provide a threshold and limit how many still images can be linked by association, so that the CPU 101 keeps the count of still images that are extracted as images included in the same group scene within a range indicated by the set threshold.

A group scene (B′) is a group scene that includes a still image (e′), which is the processing target serving as the reference, and a moving image (f′), which is not the processing target and which has been photographed within the given distance M (m) from the photographing location of the still image (e′). In other words, when the still image (e′) is the reference, the moving image (f′) is within the given distance M (m), and the still image (e′) and the moving image (f′) are extracted as components belonging to the same group scene (B′) in Steps S800 to S803. The CPU 101 in this case can ultimately employ a suitable stream segment after temporarily extracting the entire stream of the moving image (f′), based on at least one of the specified template, the result of image analysis, and photographing information.

FIG. 17 is a conceptual diagram illustrating an example of how visual effects are given when the operation of Step S806 in the flow chart of FIG. 12 uses the photographing location as ancillary information. FIG. 17 illustrates an example of allocating displaying effects to the group scene (A′) and an example of allocating displaying effects to the group scene (B′).

An example of displaying effects allocated to the group scene (A′) is described first. In this example, a visual effect based on the photographing location is to display the still image (a′), the still image (b′), and the still image (c′) in a manner that aligns the still images by photographing date/time, and to display a map of the same geographical area on the same screen as well by composition. For the duration of the display period of each still image, a mark indicating the photographing location of the still image is displayed superimposed on the map based on photographing location information of the still image. This provides a displaying effect that enables the user to check photographing locations on the map while a plurality of still images included in the same group scene are displayed. Note that, map data may be saved in a recording medium in the PC 100 or may be acquired from a remote device such as a server on the Internet. The latitude and the longitude of the photographing location are identified from the photographing location information allocated to each image, which enables each image and the location on the map to be mapped.

An example of displaying effects allocated to the group scene (B′) is described next. This example employs a data set that is obtained by extracting the processing target still image (e′) and a video stream segment and audio stream segment of the moving image (f′), which is not a processing target. In this example, a visual effect based on the photographing location is a displaying effect in which video images of a scene is created by compositing the still image (e′) and a specific video stream segment of the moving image (f′), and then adding the audio stream segment of the moving image (f′). A uniform displaying effect is thus allocated to a plurality of images included in the same group scene.

An example of using personal identification information as ancillary information is described next. In this example, the CPU 101 is configured to operate, for example, as follows with respect to the operations of Steps S800 to S803 and the operation of Step S806 in the flow chart of FIG. 12.

The CPU 101 first extracts, as the same group, images that have the same person (or animal) as a subject from candidate images. A subject in an image can be determined from the characteristics of the image with the use of, for example, a known facial recognition technology. In the case where personal identification information of each image is recorded in the database 113 in advance, the subject can be identified based on information in the relevant storing fields of the database 113.

When personal identification information is used, a group scene is created for the same person (animal). For example, when it is determined that a still image and a moving image have captured the same person (animal), the still image and a specific video stream segment and a specific audio stream segment that are included in the moving image are used to create a scene to which the composition effect 1420 or a similar displaying effect is allocated. As to candidates and conditions for determining whether subjects are the same person (animal), the user may separately set a target person or animal in one of the steps from Step S500 to S502. The target to be identified may be subjects other than a person or an animal, and the algorithm for the identification is not limited to a particular algorithm.

Other than embodiments that use the photographing period, the photographing location, and personal identification information as ancillary information, the present invention may be embodied in a mode that uses at least one of information indicating the photographer, information indicating the camera type, and information indicating the photographing mode. For example, there are various photographing modes including 2D/3D modes and nightscape/indoor modes. By using these photographing modes as ancillary information and treating a plurality of images photographed in the same mode or similar modes as one group, a movie that has a more uniform look can be created. A group may be determined also by using different types of ancillary information in combination. As in the embodiment described above, which type of ancillary information is to be used may depend on the template, or the user may set which type of ancillary information is to be used preferentially.

In the embodiments described above, the PC 100 functions as an image editing device of the present invention, but the present invention is not limited to this mode. The image editing device can be any electronic device that has a processor capable of executing a program in which the processing procedures described above are defined. A program that defines the processing procedures described above can be recorded on a recording medium such as a CD-ROM or a DVD-ROM, or can be distributed via telecommunication lines. If the program is run on a server disposed in, for example, a data center, a service can be provided in the form of so-called cloud computing to a user located in a place remote from the data center. Another possible mode is to configure a video camera so as to execute the processing procedures described above and connect the video camera to a display on which a movie is displayed.

The present invention relates to an electronic device capable of image editing operations. The present invention is not limited to the application to the PC 100, and can also be applied to cellular phones, video cameras, and other electronic devices that allow image editing operations. The present invention is also applicable to recording media such as CDs and DVDs that store a program capable of executing the same functions.

While the present invention has been described with respect to embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2011-075028 filed on Mar. 30, 2011 and No. 2012-040036 filed on Feb. 27, 2012, the entire contents of which are hereby incorporated by reference.

What is claimed is:

1. An image editing device configured to create a sequence of images by combining a plurality of images each of which has ancillary information,
the image editing device comprising:
an input interface configured to receive a plurality of candidate images that are candidates for images used in the sequence of images; and
an image editing unit configured to create the sequence of images by giving a characteristic displaying effect to each group consisting of at least two images that are extracted from the plurality of candidate images based on the ancillary information, and then by aligning the groups.

2. An image editing device according to claim 1,
wherein the input interface receives, from a user, the plurality of candidate images, information that defines a total play time of the sequence of images, and information that defines a configuration of the sequence of images, and
wherein, based on the information that defines the total play time and the information that defines the configuration, the image editing unit determines a play time for each of a plurality of scenes that constitute the sequence of images.

3. An image editing device according to claim 2, wherein, based on the ancillary information, the image editing unit sorts the plurality of candidate images into images that constitute groups and images that do not constitute groups, allocates the images that constitute groups to one of the plurality of scenes on a group-by-group basis, and allocates at least part of the images that do not constitute groups to remaining scenes of the plurality of scenes on an image-by-image basis.

4. An image editing device according to claim 2, wherein the information that defines the configuration is determined by the user by selecting one template out of a plurality of prepared templates.

5. An image editing device according to claim 1, wherein the image editing unit uses, as a reference, a value of ancillary information attached to a still image or a moving image that is included in the plurality of candidate images, and executes processing of detecting from among the plurality of candidate images another still image or a moving image whose ancillary information has a value within a given range from the reference, to thereby determine the groups.

6. An image editing device according to claim 5, wherein the image editing unit determines the groups by executing the processing for every still image or every moving image that is included in the plurality of candidate images.

7. An image editing device according to claim 1, wherein the displaying effect given to each group separately includes an effect in which at least two images belonging to the group are displayed in a same display area.

8. An image editing device according to claim 7, wherein the displaying effect includes an effect in which at least one of the at least two images displayed in the same display area performs at least one of a shifting action, an expansion action, and a reduction action.

9. An image editing device according to claim 1, wherein the ancillary information comprises at least one of information that indicates a photographing period, information that indicates a photographing location, and information for identifying a subject.

10. An image editing method of creating a sequence of images by combining a plurality of images each of which has ancillary information, comprising:
receiving a plurality of candidate images that are specified as editing targets; and
creating the sequence of images by giving a characteristic displaying effect to each group consisting of at least two images that are extracted from the plurality of candidate images based on the ancillary information, and then by aligning the groups.

11. A computer program, stored on a non-transitory computer-readable medium, to be executed by a computer mounted in an image editing device for creating a sequence of images by combining a plurality of images each of which has ancillary information, the program causes the computer to execute:
receiving a plurality of candidate images that are specified as editing targets; and
creating the sequence of images by giving a characteristic displaying effect to each group consisting of at least two images that are extracted from the plurality of candidate images based on the ancillary information, and then by aligning the groups.
